(19) United States
(12) Patent Application Publication
(10) Pub. No.: US 2019/0213340 A1
(43) Pub. Date: Jul. 11, 2019

(54) METHODS OF CONTROLLING ACCESS TO KEYS AND OF OBSCURING INFORMATION AND ELECTRONIC DEVICES

(71) Applicant: TRW Limited, Solihull West Midlands (GB)

(72) Inventors: Martin John Thompson, Solihull West Midlands (GB); Ian Richard Alan Hawkes, Droitwich Spa Worcestershire (GB)

(73) Assignee: TRW Limited, Solihull West Midlands (GB)

(21) Appl. No.: 16/325,927

(22) PCT Filed: Aug. 18, 2017
(86) PCT No.: PCT/GB2017/052450

§ 371 Date: Feb. 15, 2019

(30) Foreign Application Priority Data
Aug. 18, 2016 (GB) 1614147.5

(51) Int. Cl. G06F 21/62; G06F 21/73; H04L 9/08; G06F 21/44; G06K 19/06; B23K 26/364

(52) U.S. Cl. CPC G06F 21/62; G06F 21/73; H04L 9/0894; B23K 26/364; G06F 21/44; G06K 19/06037; H04L 9/0869

(57) ABSTRACT

A method of obscuring information carried visibly on a surface of an integrated circuit of an electronic device, the method comprising obscuring the information so as to replace the information with a visual representation of information relating to the device. Also, a method of controlling access to a first key which controls access to an electronic device, the method comprising storing an encrypted key, being the first key encrypted with a second key, as a visible representation on the device. The encrypted key can be stored in storage of the device such as non-volatile memory. Furthermore, a method of controlling access to a first key which controls access to an electronic device, in which the device comprises a processor having a full operating function set, the method comprising storing an encrypted key, being the first key encrypted with a second key, at the device in a manner that access to the encrypted key does not require the full operating function set of the processor.

### CROSS-REFERENCE To RELATED APPLICATIONS

This application is a national stage of International Application No. PCT/GB2017/052450, filed 18 Aug. 2017, the disclosures of which are incorporated herein by reference in entirety, and which claimed priority to Great Britain Patent Application No. 1614147.5, filed 18 Aug. 2016, the disclosures of which are incorporated herein by reference in entirety.

### BACKGROUND TO THE INVENTION

This invention relates to methods of controlling access to keys, to electronic devices and to a method of obscuring information.

It is often desirable to control access to an electronic device through the use of cryptographic keys. For example, modern vehicles typically use one or more electronic control units (ECUs) to control functions of the vehicle, based upon inputs to the ECU, typically from sensors of the vehicle. In an automobile, this would typically include brake and/or steering actuators, amongst various others.

In this example, it is often desirable to control access to certain functions of the ECU, especially debugging functions. In particular, malicious third parties could use those functions to their own ends, potentially to gain control of the ECU and/or the vehicle and so it desirable to keep some functions as secure as possible.

It is possible to do this through the use of cryptographic keys, such as is discussed in U.S. Pat. No. 6,161,180. For security, each ECU must have a different secret key. This could be established from the ECU serial number via a secret key which only the manufacturer holds; however if this secret key is ever compromised then all similar ECUs are similarly compromised for ever.

To date, this has therefore meant that the manufacturer has to keep a database of all of the keys, and that those rightfully wishing to access the keys must have access to the database. Securing access to such a large database is non-trivial.

Furthermore, for added security, some parties find it desirable, for reasons of obfuscation, to remove any identifying data which would normally be present on the surface integrated circuits forming the ECU (for example, to remove the manufacturer's details and the model numbers). This generally requires a separate laser etching step.

### SUMMARY OF THE INVENTION

According to a first aspect of the invention, there is provided a method of controlling access to a first key which controls access to an electronic device, the method comprising storing an encrypted key, being the first key encrypted with a second key, as a visible representation on the device.

Thus, by encrypting the first key with a second key, it can be safely stored at the device, and need not be stored in a database; indeed, the method would typically not comprise storing the first key in a database remote from the device with other first keys. By storing the encrypted key as a visible representation, it is easily accessible and can be accessed by anyone with physical access to the device and the means to understand the representation. It can be accessed even in the case where a processor of the device is operating in a degraded state.

The first key may control access to a processor of the device.

In one example, the visual representation could be a machine-readable graphical representation, such as a one or two dimensional barcode. Alternatively, the visual representation could be a textual representation, such as a numerical presentation of the encrypted key.

The visual representation could be carried on a label attached to the device. However, in an alternative embodiment, the visual representation could be carried on a processor of the device. Typically, the visual representation would be etched onto a surface of the processor. The etching may obscure any other information that was previously carried on the processor. This conveniently carries out two functions simultaneously

indeed, the method may comprise the step of etching the visual representation onto the surface of the processor so as to obscure any information that was previously carried on the surface. The visual representation may be encoded in a Manchester code; this has been found to provide a more thorough obscuration of the information as it requires at least one change of etching per bit.

The method may comprise reading the visual representation from the device. Typically, this would be carried out optically. The method may comprise reading the visual representation with a camera.

The method may comprise encrypting the first key with the second key to form the encrypted key. The method may also comprise decrypting the encrypted key to form a decrypted first key using the second key. The method may also comprise using the decrypted first key to access the device.

Furthermore, the encrypted key may have been signed, and the method may comprise signing the first key in order to form the encrypted key. Typically, the signing will be with a third key having private and public counterparts. The method may comprise making the public counterpart public, or providing the public counterpart to a user who wishes to authenticate the device. Alternatively, the method may comprise not signing the first key.

The second key may comprise private and the public counterparts, such that decrypting the encrypted key requires the private counterpart of the second key; the encryption of the first key may be with the public counterpart of the second key.

The device may comprise a processor and storage external to the processor. The encrypted key may additionally be stored in the external storage. Typically, the storage will be a non-volatile storage. This may be useful where the processor is not functioning fully; the method may comprise reading the encrypted key from the storage and typically decrypting the encrypted key to form a decrypted first key.

According to a second aspect of the invention, there is provided an electronic device which has a first key which controls access to the device, the device carrying a visual representation of an encrypted key, being the first key encrypted with a second key.

Thus, by encrypting the first key with a second key, it can be safely stored at the device, and need not be stored in a database. By storing the encrypted key as a visible representation, it is easily accessible and can be accessed by anyone with physical access to the device and the means to understand the representation. It can be accessed even in the case where a processor of the device is operating in a degraded state.

In one example, the visual representation could be a machine-readable graphical representation, such as a one or two dimensional barcode. Alternatively, the visual representation could be a textual representation, such as a numerical presentation of the encrypted key.

The visual representation could be carried on a label attached to the device. However, in an alternative embodiment, the visual representation could be carried on a processor of the device. Typically, the visual representation would be etched onto a surface of the processor. The etching may obscure any other information that was previously carried on the processor. This conveniently carries out two functions simultaneously. The visual representation may be encoded in a Manchester code; this has been found to provide a more thorough obscuration of the information as it requires at least one change of etching per bit.

Furthermore, the encrypted key may have been signed. Typically, the signing will be with a third key having private and public counterparts. The second key may comprise private and the public counterparts, such that decrypting the encrypted key requires the private counterpart of the second key; the encryption of the first key may be with the public counterpart of the second key.

The device may comprise a processor and storage external to the processor. The encrypted key may additionally be stored in the storage. Typically, the storage will be a non-volatile storage. This may be useful where the processor is not functioning fully; the method may comprise reading the encrypted key from the storage and typically decrypting the encrypted key to form a decrypted first key.

According to a third aspect of the invention, there is provided a method of controlling access to a first key which controls access to an electronic device, in which the device comprises a processor and storage external to the processor, the method comprising storing an encrypted key, being the first key encrypted with a second key, in the storage.

Thus, by encrypting the first key with a second key, it can be safely stored at the device, and need not be stored in a database; indeed, the method would typically not comprise storing the first key in a database remote from the device with other first keys. By storing the encrypted key in the storage, it is easily accessible and can be accessed by anyone with physical access to the device and the means extract the encrypted key from the storage. It can potentially be accessed even in the case where a processor of the device is operating in a degraded state.

Typically, the storage will be a non-volatile storage. This is again useful where the processor is not functioning fully; the method may comprise reading the encrypted key from the storage and typically decrypting the encrypted key to form a decrypted first key.

Furthermore, the encrypted key may have been signed, and the method may comprise signing the first key in order to form the encrypted key. Typically, the signing will be with a third key having private and public counterparts. The method may comprise making the public counterpart public, or providing the public counterpart to a user who wishes to authenticate the device.

The second key may comprise private and the public counterparts, such that decrypting the encrypted key requires the private counterpart of the second key; the encryption of the first key may be with the public counterpart of the second key.

According to a fourth aspect of the invention, there is provided an electronic device which has a first key which controls access to the device, in which the device comprises a processor and storage external to the processor, the storage storing an encrypted key, being the first key encrypted with a second key, in the storage.

Thus, by encrypting the first key with a second key, it can be safely stored at the device, and need not be stored in a database; indeed, the method would typically not comprise storing the first key in a database remote from the device with other first keys. By storing the encrypted key in the storage, it is easily accessible and can be accessed by anyone with physical access to the device and the means extract the encrypted key from the storage. It can potentially be accessed even in the case where a processor of the device is operating in a degraded state.

Typically, the storage will be a non-volatile storage. This is again useful where the processor is not functioning fully.

Furthermore, the encrypted key may have been signed, and the method may comprise signing the first key in order to form the encrypted key. Typically, the signing will be with a third key having private and public counterparts. The method may comprise making the public counterpart public, or providing the public counterpart to a user who wishes to authenticate the device.

The second key may comprise private and the public counterparts, such that decrypting the encrypted key requires the private counterpart of the second key; the encryption of the first key may be with the public counterpart of the second key.

According to a fifth aspect of the invention, there is provided a method of controlling access to a first key which controls access to an electronic device, in which the device comprises a processor having a full operating function set, the method comprising storing an encrypted key, being the first key encrypted with a second key, at the device in a manner that access to the encrypted key does not require the full operating function set of the processor.

Thus, by encrypting the first key with a second key, it can be safely stored at the device, and need not be stored in a database; indeed, the method would typically not comprise storing the first key in a database remote from the device with other first keys.

The processor may additionally have a degraded function set which is smaller than the full operating function set. Access to the encrypted key by the device may be possible in the degraded function set. Alternatively or additionally, access to the encrypted key by the device or an external tool may be possible even if the processor is not functioning (at all).

The method may comprise encrypting the first key with the second key to form the encrypted key. The method may also comprise decrypting the encrypted key to form a decrypted first key using the second key. The method may also comprise using the decrypted first key to access the device.

Furthermore, the encrypted key may have been signed, and the method may comprise signing the first key in order to form the encrypted key. Typically, the signing will be with a third key having private and public counterparts. The method may comprise making the public counterpart public, or providing the public counterpart to a user who wishes to authenticate the device.

The second key may comprise private and the public counterparts, such that decrypting the encrypted key requires the private counterpart of the second key; the encryption of the first key may be with the public counterpart of the second key.

According to a sixth aspect of the invention, there is provided an electronic device which has a first key which controls access to the device, in which the device comprises a processor having a full operating function set, in which there is stored at the device an encrypted key, being the first key encrypted with a second key, in a manner that access to the encrypted key does not require the full operating function set of the processor.

Thus, by encrypting the first key with a second key, it can be safely stored at the device, and need not be stored in a database; indeed, the method would typically not comprise storing the first key in a database remote from the device with other first keys.

The processor may additionally have a degraded function set which is smaller than the full operating function set. Access to the encrypted key by the device may be possible in the degraded function set. Alternatively or additionally, access to the encrypted key by the device or an external tool may be possible even if the processor is not functioning (at all).

Furthermore, the encrypted key may have been signed. Typically, the signing will be with a third key having private and public counterparts. The second key may comprise private and the public counterparts, such that decrypting the encrypted key requires the private counterpart of the second key; the encryption of the first key may be with the public counterpart of the second key.

According to a seventh aspect of the invention, there is provided a method of obscuring information carried visibly on a surface of an integrated circuit (IC) of an electronic device, the method comprising obscuring the information so as to replace the information with a visual representation of information relating to the device.

Thus, where it is desirable to obscure the information (such as IC manufacturer, IC model and/or serial number), rather than simply wiping the information off the surface of the IC, the surface can be used to store and display useful information relating to the IC. Thus, the storage and display of such useful information can synergistically combine with the obscuration of the unwanted information.

The information relating to the device could comprise at least one of the following:
device serial number
device manufacturing date(s)
device software version
device manufacturing site

Additionally, or alternative, the information relating to the device could comprise an encrypted key, being a first key which controls access to the device, encrypted with a second key.

In one example, the visual representation could be a machine-readable graphical representation, such as a one or two dimensional barcode. The visual representation may be encoded in a Manchester code or other code that requires at least one change of visible appearance per bit of information; we believe that this will provide a more thorough obscuration of the information.

Alternatively, the visual representation could be a textual representation, such as a numerical presentation of the encrypted key.

The obscuring will preferably be through an etching process into the surface, typically a laser etching.

In any of the above aspects, the device may be an electronic control unit, typically that of a vehicle. As such, the electronic control unit may be arranged to control the operation of a further device, typically based upon inputs received from outside the device. The further device will typically be part of the vehicle, such as a steering, braking or engine system or subsystem. The vehicle may be a road vehicle, such as an automobile, or a track vehicle, such as a train. Alternatively, it may be an aeroplane.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows a block diagram of an electronic control unit (ECU) in accordance with an embodiment of the invention;

FIG. 2 shows a flow chart showing the encryption method used in the embodiment of FIG. 1;

FIG. 3 is a cross section through the ECU of FIG. 1;

FIG. 4 is an example two dimensional bar code used in the embodiment of FIG. 1;

FIG. 5 shows a flow chart showing the decryption method used in the embodiment of FIG. 1;

FIG. 6 shows the processor of the ECU of FIG. 1 before the data carried on its top surface has been obscured; and

FIG. 7 shows the processor of FIG. 6 after the data has been obscured with the barcode of FIG. 4.

### DETAILED DESCRIPTION OF THE INVENTION

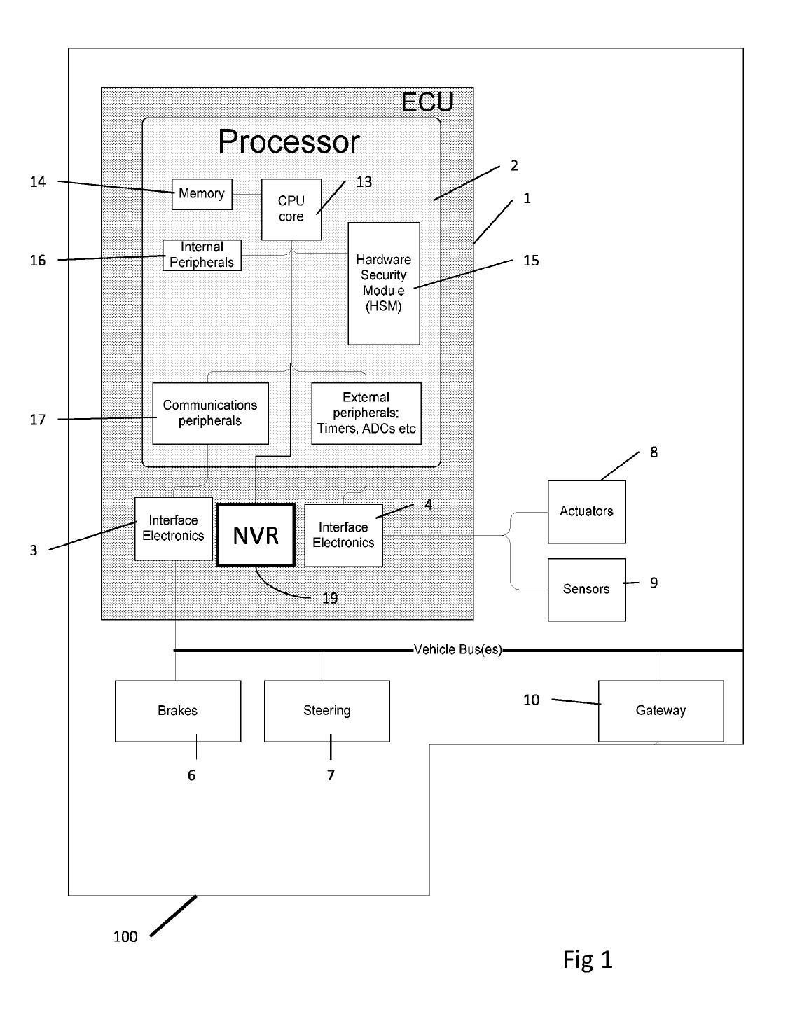

An electronic control unit (ECU) 1 is shown within a vehicle 100 in FIG. 1 of the accompanying drawings, which can be used in the various embodiments of the invention. The vehicle in this case is an automobile. The electronic control unit 1 comprises a processor 2, which is a single integrated circuit (IC), connected to external interfaces 3, 4 within the ECU 1. External interface 3 connects the ECU 1 to a CAN bus 5, to which other units (such as Brake ECU 6, Steering ECU 7, and a Gateway 10 are connected). External interface 4 connects the ECU 1 to actuators 8 (e.g. brake or steering actuators) and sensors 9 (e.g. speed or position sensors) of the vehicle 100.

The gateway can, for example, be connected to a debugging interface, such as a STAG (Joint Test Action Group) interface. In order to access certain restricted functionality of the ECU (“the functionality”), particularly for debugging reasons if the ECU has been returned for repair, it is necessary to provide a first key to the ECU through the debug port.

The processor 2 itself comprises, as discussed above, a single integrated circuit, which has several features. It has a processor core 13 which carries out most of the processing functions of the ECU 1. It has memory 14, in which data and program instructions are held. There are various internal peripherals 16, such as watchdog timers, signal processing accelerators, direct-memory-access (DMA) controllers. There are communications peripherals which communicate with the external interface 3. There are also a set of peripherals, such as analogue to digital converters (ADCs), timers and so on which communicate with the external interface 4.

The processor also has a hardware security module (HSM) 15, which is tamper resistant; whilst tamper resistance HSMs are well known in the art, and the skilled man would have little trouble implementing such an HSM (see, for example, the techniques described in chapter 16 of the book “Security Engineering” (second edition), by Ross Anderson, ISBN 978-0470068526), in an example, the HSM can be made tamper resistant by including it on the same area of silicon integrated circuit as the processor core. Metal layers can be added in the integrated circuit to detect probing attempts, and voltage sensors to detect voltage glitches which can cause malicious intention malfunctions.

In order to control access to the functionality, the first key must be provided to the processor. However, it is undesirable for the ECU manufacturer to have to store a database of the keys for all ECUs that it manufactures, as that is open to attack. As such, it is preferable that the key be stored securely at the ECU.

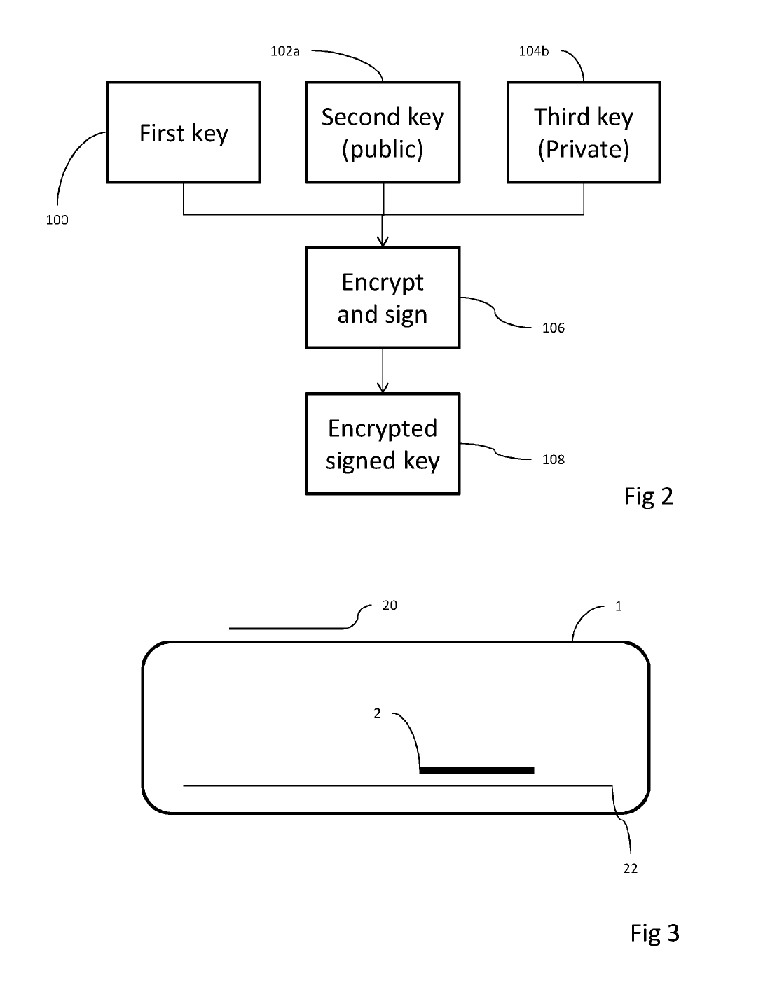

As such, an encrypted signed key is generated in accordance with the flowchart shown in FIG. 2. In this, the first key 100 is generated, typically as a random number. Two further key pairs have already been generated—a second key 102 having public 102a and private 102b parts, and a third key 104 having public 104a and private 104b parts. The public part 102a of the second key is then used to encrypt the first key, and the private part 104b of the third key is used to sign the first key at step 106. Hashes of each of the public part 102a of the second key and the public part 104a of the third key may be appended to the resultant data to form an encrypted signed key 108. There may be many private keys in use throughout the manufacturer's product range, the hashes of the public keys which have been used in a specific instance can be appended to the encrypted signed key to identify more easily which key(s) should be used to decrypt (and authenticate if this feature is included) the first key.

Typically, the private keys would not leave the manufacturer's facilities, or at least facilities authorised by them, and so the above steps would generally take place at manufacture of the ECU.

The encrypted signed key 108 can then safely be stored at the ECU I without unauthorised parties being able to access the first key. There are different means by which the encrypted signed key 108 can be stored. Ideally, the encrypted signed key 108 would be stored in or at the ECU in so that it can be accessed even if the processor is not functioning, or at least is only functioning in a degraded state.

In one embodiment, shown in FIG. 3 of the accompanying drawings, the encrypted signed key is carried as a visual representation on a label 20 on the outside of the ECU 1 (or in any other convenient position). Alternatively, the visual representation could be:

carried on a “top” surface of the processor 2 (that is, the surface facing away from the circuit board 22 on which the processor 2 is mounted), by laser etching onto the top surface of the package forming the integrated circuit of the processor 2;

laser etched onto the printed circuit board (PCB) on which the processor 2 is mounted;

on label on the PCB; or

any combination of the above, to enhance availability in case of damage.

The visual representation could simply be a numeric (e.g. hexadecimal) representation of the encrypted signed key, for example:

a. dbdc15c446a07e5de1a790a2bfa6816c3cf7d385d924250fb2eb90419115f8424b42 1e2bad365328226d9090b917bde19b2ccdd96f06c13ed760b38daaaf32b2993a0557 65cd301a249d1880878c7e2

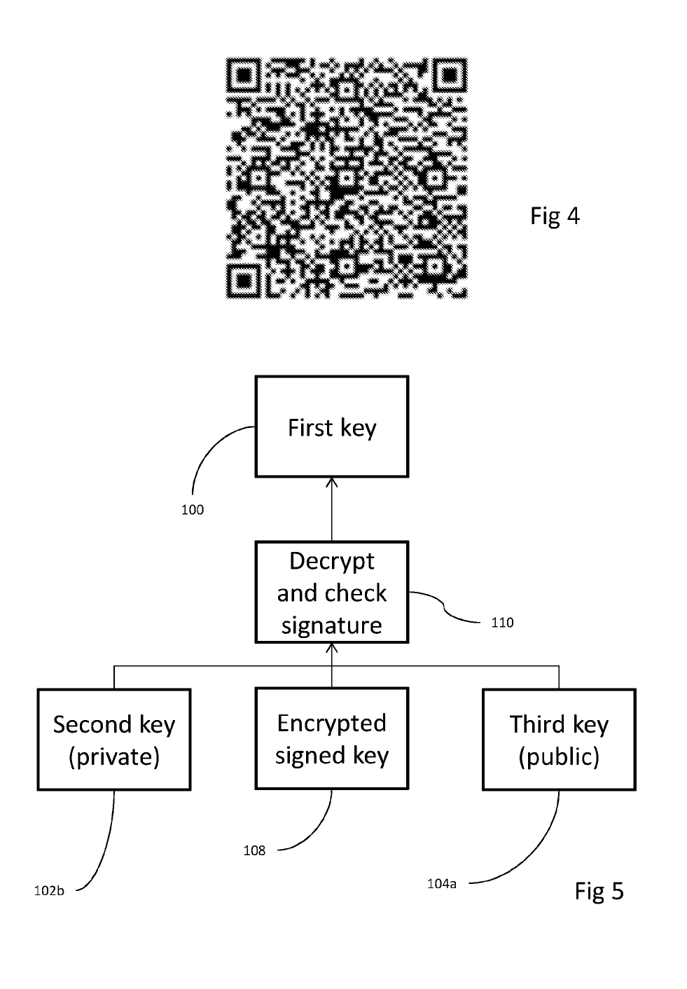

Alternatively, and more conveniently, it could be represented in some machine readable way, such as a one- or two-dimensional barcode. Examples of this include the QR-Code (RTM) described in the standard. ISO/IEC 18004:2015, or the Data Matrix described in various standards including ISO/IEC 16022:2006. A QR code encoding the same information as given in the above example is shown in FIG. 4 of the accompanying drawings. The visual representation can then be read using a digital camera and decoded back into binary form.

In an alternative embodiment, the encrypted signed key 108 is stored in non-volatile random access memory (NVR) 19 of the ECU. Even if the processor 2 is degraded, only partially functioning or potentially not functioning at all, then it may still be able to read the encrypted signed key 108 out of the NVR, for example by using a memory reader with cables attached to each pin of an IC forming the NVR 19.

In order to allow access to the first key, the reverse procedure is carried out to that of FIG. 2, shown in FIG. 5 of the accompanying drawings. The hashes of the second and third keys are extracted from the encrypted and signed key 108 and used to select the appropriate second key private part 102b and third key public part 102a. Alternatively, each private key could be tried in turn. A decryption and signature checking step 110 uses the third key public part 102a to check the authenticity of the encrypted signed key 108, whereas the second key private part 102b is used to decrypt the encrypted signed key 108. This recovers the first key 100, which can then be used by the user to access the restricted functionality of the processor 2.

Where the visual representation is on the processor 2, and particularly where a machine-readable representation such as a barcode is used, the placing of that visual representation on the processor 2 can conveniently also be used to obscure any unwanted information that was previously carried on the processor 2.

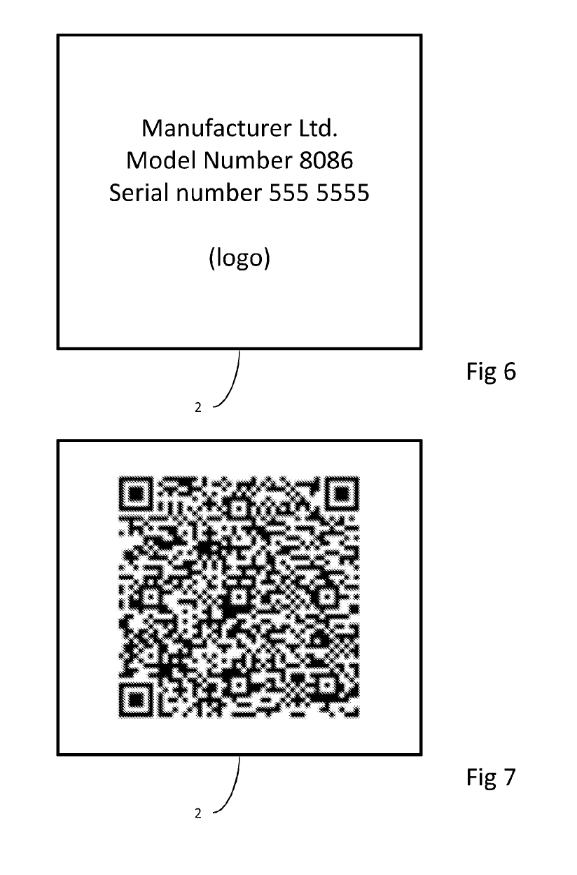

A schematic view of a processor 2 before obscuration can be seen in FIG. 6 of the accompanying drawings. This carries such data as the IC manufacturer, model number, serial number and a manufacturer's logo. Where it is desired to obscure this information (typically, for obfuscation purposes, to make it harder for third parties to determine what the IC in question does), then replacing this information with the visual representation can serve two purposes—to obscure the undesired information, and to replace it with more useful information, such as in this case the encrypted signed key. Other information could be used, such as:
ECU serial number
ECU manufacturing date(s)
ECU software version
ECU manufacturing site

This other data could be machine encoded in a two dimensional barcode

As can be seen in FIG. 7 of the accompanying drawings, the act of placing the visual representation onto the top surface of the IC has obscured the data that was previously present. One particularly convenient method of achieving this is laser etching.

As such, by using the above methods, where many ECUs are produced, there is provided a distributed database of first keys which is very hard to attack. It is much simpler for the ECU manufacturer to keep the private parts of the keys secure than a large and unwieldy database.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A method of Obscuring information carried visibly on a surface of an integrated circuit of an electronic device, the method comprising: obscuring the information so as to replace the information with a visual representation of information relating to the electronic device.

2. The method of claim 1, in which the information relating to the electronic device comprises at least one of the following:
device serial number
device manufacturing date(s)
device software version
device manufacturing site

3. The method of claim 2, in which the information relating to the electronic device comprises an encrypted key, being a first key which controls access to the device, encrypted with a second key.

4. The method of claim 1, in which the visual representation comprises a machine-readable graphical representation.

5. The method of claim 4, in which the visual representation is encoded in a Manchester code or other code that requires at least one change of visible appearance per bit of information.

6. The method of claim 1, in which the visual representation comprises a textual representation.

7. The method of claim 1, in which the obscuring comprises an etching process into the surface.

8-39. (canceled)

40. The method of claim 4, in which the visual representation comprises a machine-readable graphical representation, configured as a one or two dimensional barcode.

41. The method of claim 7, in which the etching process is a laser etching.
